(19) United States
(12) Patent Application Publication
(10) Pub. No.: US 2015/0140319 A1
(43) Pub. Date: May 21, 2015

(54) FUSER MEMBER AND METHOD OF MANUFACTURE

(71) Applicant: Xerox Corporation, Norwalk, CT (US)

(72) Inventors: Yu Qi, Penfield, NY (US); Qi Zhang, Milton (CA); Brynn Mary Dooley, Toronto (CA); Suxia Yang, Mississauga (CA); Nan-Xing Hu, Oakville (CA)

(73) Assignee: Xerox Corporation, Norwalk, CT (US)

(21) Appl. No.: 14/082,816

(22) Filed: Nov. 18, 2013

(51) Int. Cl. G03G 15/20; B05D 1/36; D01D 5/00

(52) U.S. Cl. CPC G03G 15/20; D01D 5/0007; B05D 1/36
USPC 428/323; 524/538; 524/496; 524/514; 428/421; 427/462

(57) ABSTRACT

A fuser member including a substrate and a release layer disposed on the substrate is provided. The fuser member includes a substrate and a release layer disposed on the substrate. The release layer includes non-woven polymer fibers having graphene particles dispersed along the fibers. A method of manufacturing the release layer is provided.

### BACKGROUND

1. Field of Use

This disclosure is generally directed to surface layers for fuser members useful in electrophotographic imaging apparatuses, including digital, image on image, and the like.

2. Background

Thermal conductivity is an important property for coatings used for thermal control. Fuser topcoats with high thermal conductivity enable higher fusing speed, wider fusing latitude, and lower fusing temperature. Therefore, various thermally conductive fillers have been disclosed for this purpose. Graphene is a unique filler material which possesses combination of superior mechanical strength and conductivity. However, it is challenging to utilize graphene material to reinforce and improve thermal conductivity in polymer composites, as graphene particles agglomerate and are therefore difficult to uniformly disperse into a polymer composite. Poorly dispersed graphene particles in polymer composites cause defects which lead to polymer composites having reduced mechanical strength and poor thermal conductivity.

Fuser surfaces having increased thermal conductivity without negatively impacting fusing performance are desired.

### SUMMARY

According to an embodiment, there is provided a fuser member including a substrate and a release layer disposed on the substrate. The release layer includes non-woven polymer fibers having graphene particles dispersed along the fibers. The release layer includes a fluoropolymer dispersed throughout the non-woven polymer fibers.

According to another embodiment, there is provided a method of manufacturing a fuser member. The method includes providing a conductive surface. Polymeric fibers are electrospun on the conductive surface to form a non-woven polymer fiber layer. A dispersion of graphene particles and a first solvent is flow coated on the non-woven polymer fiber layer. The first solvent is removed to form a non-woven polymer fiber layer having graphene particles deposited along the polymer fibers. A mixture of a fluoropolymer and a second solvent is coated on the non-woven polymer fiber layer having graphene particles deposited along the polymer fibers having deposited graphene particles. The mixture is heated to remove the second solvent and to melt or cure the fluoropolymer thereby forming a release layer.

According to an embodiment, there is provided a fuser member including a substrate, an intermediate layer disposed on the substrate and a release layer. The release layer is disposed on the substrate. The release layer includes non-woven polymer fibers having graphene particles dispersed along the fibers. The release layer includes a fluoropolymer dispersed throughout the non-woven polymer fibers.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 depicts an exemplary fusing member having a cylindrical substrate in accordance with the present teachings.

FIG. 2 depicts an exemplary fusing member having a belt substrate in accordance with the present teachings.

FIGS. 3A-3B depict exemplary fusing configurations using the fuser rollers shown in FIG. 1 in accordance with the present teachings.

FIGS. 4A-4B depict another exemplary fusing configuration using the fuser belt shown in FIG. 2 in accordance with the present teachings.

FIG. 5 depicts an exemplary fuser configuration using a transfix apparatus.

It should be noted that some details of the FIGS. have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Illustrations with respect to one or more implementations, alterations and/or modifications can be made to the illustrated examples without departing from the spirit and scope of the appended claims. In addition, while a particular feature may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

Disclosed herein is a composition including electrospun fibers. Graphene particles are deposited along the electrospun fibers. A polymer matrix is dispersed throughout the electrospun fibers having the deposited graphene particles. The graphene particles are uniformly distributed along the fibers. The polymer matrix is a low surface energy polymeric material which fills the gaps between the electrospun fibers. The electrospun fiber materials selected are high performance polymers. The fiber network provides a framework for the graphene particles. The graphene particles are uniformly distributed along the electrospun fibers. This produces a thermally conductive layer at low loadings of the graphene particles. In addition, the electrospun fibers enable uniform distribution of graphene particles or nanoparticles in the coating layer without the need for reformulation of the graphene dispersion with a fluoropolymer. A fluoropolymer matrix material is used to provide low surface energy of the layer, which is essential for non-stick application such as for fusers.

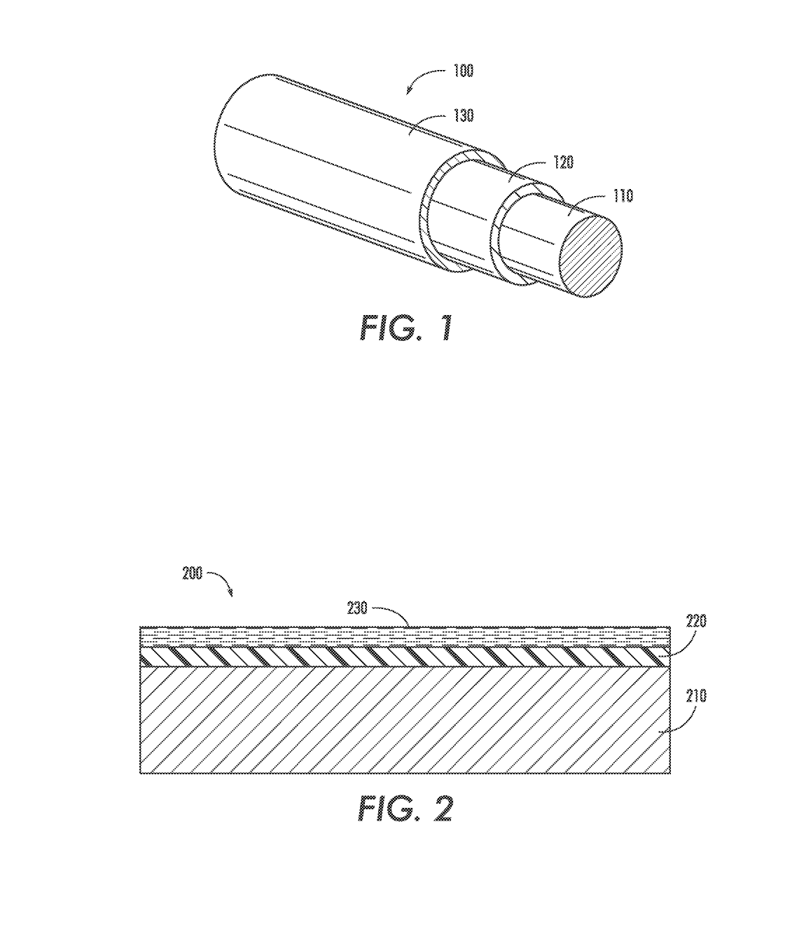

In various embodiments, the fixing member can include, for example, a substrate, with one or more functional layers formed thereon. The substrate can be formed in various shapes, e.g., a cylinder (e.g., a cylinder tube), a cylindrical drum, a belt, or a film, using suitable materials that are non-conductive or conductive depending on a specific configuration, for example, as shown in FIGS. 1 and 2.

Specifically, FIG. 1 depicts an exemplary fixing or fusing member 100 having a cylindrical substrate 110 and FIG. 2 depicts in cross-section another exemplary fixing or fusing member 200 having a belt substrate 210 in accordance with the present teachings. It should be readily apparent to one of ordinary skill in the art that the fixing or fusing member 100 depicted in FIG. 1 and the fixing or fusing member 200 depicted in FIG. 2 represent generalized schematic illustrations and that other layers/substrates can be added or existing layers/substrates can be removed or modified.

In FIG. 1, the exemplary fixing member 100 can be a fuser roller having a cylindrical substrate 110 with one or more functional layers 120 (also referred to as intermediate layers) and a surface layer 130 formed thereon. In various embodiments, the cylindrical substrate 110 can take the form of a cylindrical tube, e.g., having a hollow structure including a heating lamp therein, or a solid cylindrical shaft. In FIG. 2, the exemplary fixing member 200 can include a belt substrate 210 with one or more functional layers, e.g., 220 and an outer surface 230 formed thereon.

### Substrate Layer

The belt substrate 210 (FIG. 2) and the cylindrical substrate 110 (FIG. 1) can be formed from, for example, polymeric materials (e.g., polyimide, polyaramide, polyether ether ketone, polyetherimide, polyphthalamide, polyamide-imide, polyketone, polyphenylene sulfide, fluoropolyimides or fluoropolyurethanes) and metal materials (e.g., aluminum or stainless steel) to maintain rigidity and structural integrity as known to one of ordinary skill in the art.

### Intermediate Layer

Examples of intermediate or functional layers 120 (FIG. 1) and 220 (FIG. 2) include fluorosilicones, silicone rubbers such as room temperature vulcanization (RTV) silicone rubbers, high temperature vulcanization (HTV) silicone rubbers, and low temperature vulcanization (LTV) silicone rubbers. These rubbers are known and readily available commercially, such as SILASTIC® 735 black RTV and SILASTIC® 732 RTV, both from Dow Corning; 106 RTV Silicone Rubber and 90 RTV Silicone Rubber, both from General Electric; and JCR6115CLEAR HTV and SE4705U HTV silicone rubbers from Dow Corning Toray Silicones. Other suitable silicone materials include the siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; and the like. Another specific example is Dow Corning Sylgard 182. Commercially available LSR rubbers include Dow Corning Q3-6395, Q3-6396, SILASTIC® 590 LSR, SILASTIC® 591 LSR, SILASTIC® 595 LSR, SILASTIC® 596 LSR, and SILASTIC® 598 LSR from Dow Corning. The functional layers provide elasticity and can be mixed with inorganic particles, for example SiC or Al₂O₃, as required.

Examples of intermediate or functional layers 120 (FIG. 1) and 220 (FIG. 2) also include fluoroelastomers. Fluoroelastomers are from the class of 1) copolymers of two of vinylidenefluoride, hexafluoropropylene, and tetrafluoroethylene; such as those known commercially as VITON A®, 2) terpolymers of vinylidenefluoride, hexafluoropropylene, and tetrafluoroethylene such as those known commercially as VITON B®; and 3) tetrapolymers of vinylidenefluoride, hexafluoropropylene, tetrafluoroethylene, and a cure site monomer, such as those known commercially as VITON GH® or VITON GF®. These fluoroelastomers are known commercially under various designations such as those listed above, along with VITON E®, VITON E 60C®, VITON E430®, VITON 910®, and VITON ETP®. The VITON® designation is a trademark of E.I. DuPont de Nemours, Inc. The cure site monomer can be 4-bromoperfluorobutene-1,1,1-dihydro-4-bromoperfluorobutene-1,3-bromoperfluoropropene-1,1,1-dihydro-3-bromoperfluoropropene-1, or any other suitable, known cure site monomer, such as those commercially available from DuPont. Other commercially available fluoropolymers include FLUOREL 2170®, FLUOREL 2174®, FLUOREL 2176®, FLUOREL 2177® and FLUOREL LVS 76®, FLUOREL® being a registered trademark of 3M Company. Additional commercially available materials include AFLAS™ a poly(propylene-tetrafluoroethylene), and FLUOREL II® (LII900) a poly(propylene-tetrafluoroethylenevinylidenefluoride), both also available from 3M Company, as well as the Tecnoflons identified as FOR-60KIR, FOR-LHF®, NM® FOR-THF®, FOR-TFS® TH® NH® P757® TNS®, T439 PL958® BR9151 and TN505®, available from Ausimont.

The fluoroelastomers VITON GH® and VITON GF® have relatively low amounts of vinylidenefluoride. The VITON GF® and VITON GH® have about 35 weight percent of vinylidenefluoride, about 34 weight percent of hexafluoropropylene, and about 29 weight percent of tetrafluoroethylene, with about 2 weight percent cure site monomer. Cure site monomers are available from Dupont.

For a roller configuration, the thickness of the intermediate or functional layer can be from about 0.5 mm to about 10 mm, or from about 1 mm to about 8 mm, or from about 2 mm to about 7 mm. For a belt configuration, the functional layer can be from about 25 microns up to about 2 mm, or from 40 microns to about 1.5 mm, or from 50 microns to about 1 mm.

### Release Layer or Surface Layer

The release layer or surface layer includes electrospun fibers. Graphene particles are deposited along the electrospun fibers. A polymer matrix is dispersed throughout the electrospun fibers having the deposited graphene particles. The graphene particles are uniformly distributed along the fibers. The polymer matrix is a low surface energy polymeric material which fills the gaps between the electrospun fibers.

### Adhesive Layer

Optionally, any known and available suitable adhesive layer may be positioned between the outer layer or surface layer and the intermediate layer or between the intermediate layer and the substrate layer. Examples of suitable adhesives include silanes such as amino silanes (such as, for example, HV Primer 10 from Dow Corning), titanates, zirconates, aluminates, and the like, and mixtures thereof. In an embodiment, an adhesive in from about 0.001 percent to about 10 percent solution can be wiped on the substrate. The adhesive layer can be coated on the substrate, or on the outer layer, to a thickness of from about 2 nanometers to about 10,000 nanometers, or from about 2 nanometers to about 1,000 nanometers, or from about 2 nanometers to about 5000 nanometers. The adhesive can be coated by any suitable known technique, including spray coating or wiping.

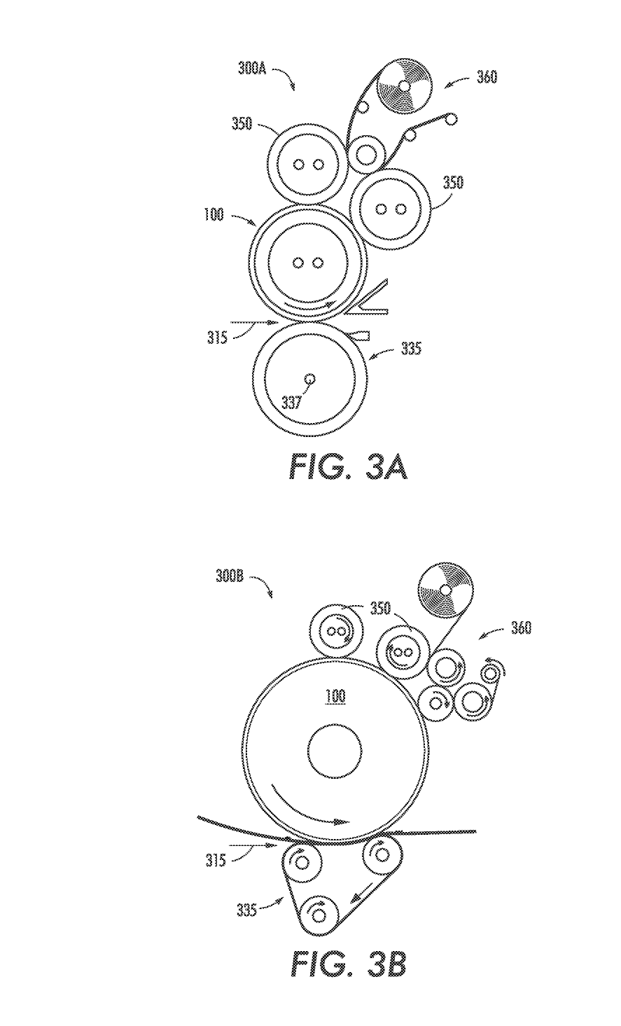

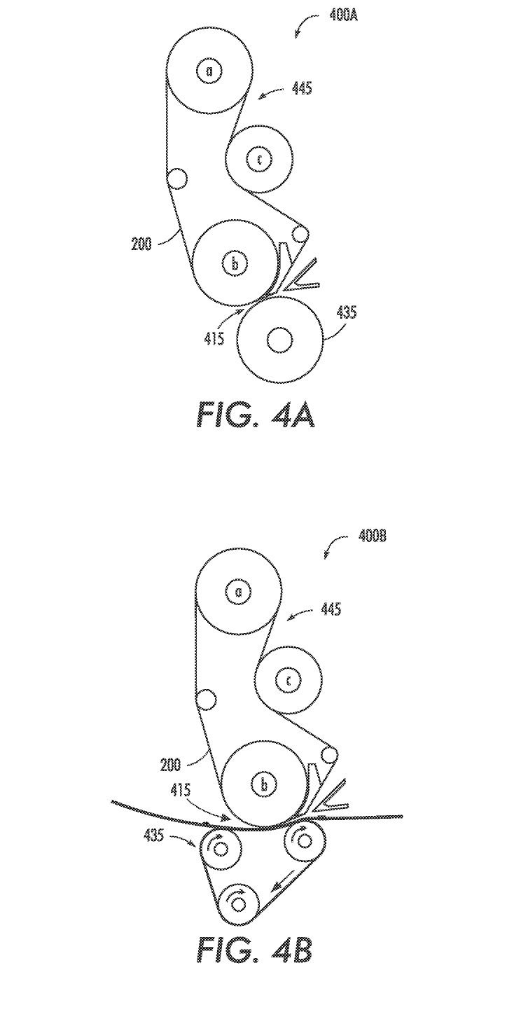

FIGS. 3A-3B and FIGS. 4A-4B depict exemplary fusing configurations for the fusing process in accordance with the present teachings. It should be readily apparent to one of ordinary skill in the art that the fusing configurations 300A-B depicted in FIGS. 3A-3B and the fusing configurations 400A-B depicted in FIGS. 4A-4B represent generalized schematic illustrations and that other members/layers/substrates/configurations can be added or existing members/layers/substrates/configurations can be removed or modified. Although an electrophotographic printer is described herein, the disclosed apparatus and method can be applied to other printing technologies. Examples include offset printing and inkjet and solid ink transfix machines.

FIGS. 3A-3B depict the fusing configurations 300A-B using a fuser roller shown in FIG. 1 in accordance with the present teachings. The configurations 300A-B can include a fuser roller 100 (i.e., 100 of FIG. 1) that forms a fuser nip with a pressure applying mechanism 335, such as a pressure roller in FIG. 3A or a pressure belt in FIG. 3B, for an image supporting material 315. In various embodiments, the pressure applying mechanism 335 can be used in combination with a heat lamp 337 to provide both the pressure and heat for the fusing process of the toner particles on the image supporting material 315. In addition, the configurations 300A-B can include one or more external heat roller 350 along with, e.g., a cleaning web 360, as shown in FIG. 3A and FIG. 3B.

FIGS. 4A-4B depict fusing configurations 400A-B using a fuser belt shown in FIG. 2 in accordance with the present teachings. The configurations 400A-B can include a fuser belt 200 (i.e., 200 of FIG. 2) that forms a fuser nip with a pressure applying mechanism 435, such as a pressure roller in FIG. 4A or a pressure belt in FIG. 4B, for a media substrate 415. In various embodiments, the pressure applying mechanism 435 can be used in a combination with a heat lamp to provide both the pressure and heat for the fusing process of the toner particles on the media substrate 415. In addition, the configurations 400A-B can include a mechanical system 445 to move the fuser belt 200 and thus fusing the toner particles and forming images on the media substrate 415. The mechanical system 445 can include one or more rollers 445a-c, which can also be used as heat rollers when needed.

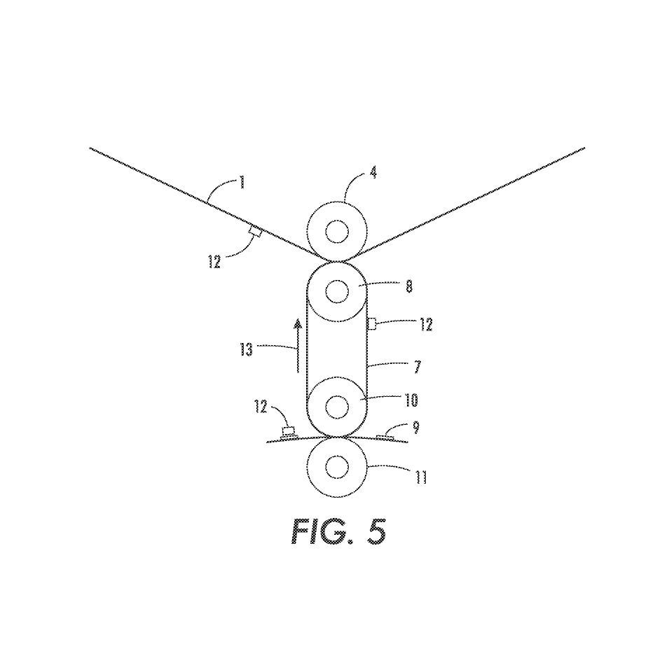

FIG. 5 demonstrates a view of an embodiment of a transfix member 7 which may be in the form of a belt, sheet, film, or like form. The transfix member 7 is constructed similarly to the fuser belt 200 described above. The developed image 12 positioned on intermediate transfer member 1 is brought into contact with and transferred to transfix member 7 via rollers 4 and 8. Roller 4 and/or roller 8 may or may not have heat associated therewith. Transfix member 7 proceeds in the direction of arrow 13. The developed image is transferred and fused to a copy substrate 9 as copy substrate 9 is advanced between rollers 10 and 11. Rollers 10 and/or 11 may or may not have heat associated therewith.

The release layer is manufactured by providing a substrate layer that is conductive. The substrate layer, described previously, can include one or more intermediate layers. Polymeric fibers are electrospun on the conductive surface to form a non-woven polymer fiber layer. Intermediate layers can be interposed between the substrate and the electrospun fibers. A dispersion including graphene particles and a solvent is flow coated on the electrospun polymeric fibers. The solvent is removed to form graphene particles uniformly deposited along the electrospun polymer fibers. A mixture of a fluoropolymer in a solvent is flow coated on the polymer fibers having the deposited graphene particles. The mixture is to remove the second solvent and melt or cure the fluoropolymer thereby having the fluoropolymer penetrate the electrospun fibers having the deposited graphene particles to form the release layer.

Nonwoven fabrics are broadly defined as sheet or web structures bonded together by entangling fiber or filaments (and by perforating films) mechanically, thermally or chemically. They include flat, porous sheets that are made directly from separate fibers or from molten plastic or plastic film. They are not made by weaving or knitting and do not require converting the fibers to yarn.

The fuser release layer is fabricated by applying the polymer fibers onto a substrate by an electrospinning process. Electrospinning uses an electrical charge to draw very fine (typically on the micro or nano scale) fibers from a liquid. The charge is provided by a voltage source. The process does not require the use of coagulation chemistry or high temperatures to produce solid threads from solution. This makes the process particularly suited to the production of fibers using large and complex molecules such as polymers. When a sufficiently high voltage is applied to a liquid droplet, the body of the liquid becomes charged, and electrostatic repulsion counteracts the surface tension and the droplet is stretched. At a critical point a stream of liquid erupts from the surface. This point of eruption is known as the Taylor cone. If the molecular cohesion of the liquid is sufficiently high, stream breakup does not occur and a charged liquid jet is formed.

Electrospinning provides a simple and versatile method for generating ultrathin fibers from a rich variety of materials that include polymers, composites and ceramics. To date, numerous polymers with a range of functionalities have been electrospun as nanofibers. In electrospinning, a solid fiber is generated as the electrified jet (composed of a highly viscous polymer solution with a viscosity range of from about 1 to about 400 centipoises, or from about 5 to about 300 centipoises, or from about 10 to about 250 centipoises) is continuously stretched due to the electrostatic repulsions between the surface charges and the evaporation of solvent. Suitable solvents include dimethylformamide, dimethylacetamide, 1-methyl-2-pyrrolidone, tetrahydrofuran, a ketone such as acetone, methylethylketone, dichloromethane, an alcohol such as ethanol, isopropyl alcohol, water and mixtures thereof. The weight percent of the polymer in the solution ranges from about 1 percent to about 60 percent, or from about 5 percent to about 55 percent to from about 10 percent to about 50 percent.

Exemplary materials used for the electrospun fiber with or without a fluoropolymer sheath can include: polyamide such as aliphatic and/or aromatic polyamide, polyester, polyimide, fluorinated polyimide, polycarbonate, polyurethane, polyether, polyoxadazole, polybenzimidazole, polyacrylonitrile, polycaprolactone, polyethylene, polypropylenes, acrylonitrile butadiene styrene (ABS), polybutadiene, polystyrene, polymethyl-methacrylate (PMMA), poly(vinyl alcohol), poly(ethylene oxide), polylactide, poly(caprolactone), poly(ether imide), poly(ether urethane), poly(arylene ether), poly(arylene ether ketone), poly(ester urethane), poly(p-phenylene terephthalate), cellulose acetate, poly(vinyl acetate), poly(acrylic acid), polyacrylamide, polyvinylpyrrolidone, hydroxypropylcellulose, poly(vinyl butyral), poly(alkly acrylate), poly(alkyl methacrylate), polyhydroxybutyrate, fluoropolymer, poly(vinylidene fluoride), poly(vinylidene fluoride-co-hexafluoropropylene), fluorinated ethylene-propylene copolymer, poly(tetrafluoroethylene-co-perfluoropropyl vinyl ether), poly((perfluoroalkyl)ethyl methacrylate), cellulose, chitosan, gelatin, protein, and mixtures thereof. In embodiments, the electrospun fibers can be formed of a tough polymer such as Nylon, polyimide, and/or other tough polymers.

Exemplary materials used for the electrospun fibers when there is no sheath or coating include fluoropolymers selected from the group consisting of: copolymers of vinylidenefluoride, hexafluoropropylene and tetrafluoropropylene and tetrafluoroethylene; terpolymers of vinylidenefluoride, hexafluoropropylene and tetrafluoroethylene; tetrapolymers of vinylidenefluoride, hexafluoropropylene, tetrafluoroethylene, and a cure site monomer; polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP) and a cure site monomer.

In embodiments, fluorinated polyimides (FPI) are used for the core with or without a sheath of the polymers in the non-woven matrix layer. Fluorinated polyimides are synthesized in high molecular weight using a known procedure as shown in Equation 1.

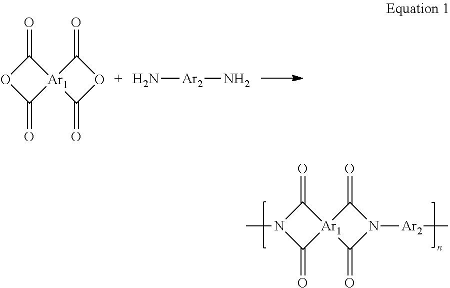

wherein one of Ar₁ and Ar₂ independently represent an aromatic group of from about 4 carbon atoms to about 60 carbon atoms; and at least one of Ar₁ and Ar₂ further contains fluorine. In the polyimide above, n is from about 30 to about 1000, or from about 40 to about 450 or from about 50 to about 400.

More specific examples of fluorinated polyimides include the following general formula:

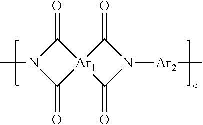

wherein Ar₁ and Ar₂ independently represent an aromatic group of from about 4 carbon atoms to about 100 carbon atoms, or from about 5 to about 60 carbon atoms, or from about 6 to about 30 carbon atoms such as such as phenyl, naphthyl, perylenyl, thiophenyl, oxazolyl; and at least one of Ar₁ and Ar₂ further contains a fluoro-pendant group. In the polyimide above, n is from about 30 to about 500, or from about 40 to about 450 or from about 50 to about 400.

Ar₁ and Ar₂ can represent a fluoroalkyl having from about 4 carbon atoms to about 100 carbon atoms, or from about 5 carbon atoms to about 60 carbon atoms, or from about 6 to about 30 carbon atoms.

In embodiments, the electrospun fibers can have a diameter ranging from about 5 nm to about 50 μm, or ranging from about 50 nm to about 20 μm, or ranging from about 100 nm to about 1 μm. In embodiments, the electrospun fibers can have an aspect ratio of about 100 or higher, e.g., ranging from about 100 to about 1,000, or ranging from about 100 to about 10,000, or ranging from about 100 to about 100,000. In embodiments, the non-woven fabrics can be non-woven nano-fabrics formed by electrospun nanofibers having at least one dimension, e.g., a width or diameter, of less than about 1000 nm, for example, ranging from about 5 nm to about 500 nm, or from 10 nm to about 100 nm.

In embodiments, the sheath on the polymer fibers is formed by coating the polymer fiber core with a fluoropolymer and heating the fluoropolymer. The fluoropolymers have a curing or melting temperature of from about 150° C. to about 360° C. or from about 280° C. to about 330° C. The thickness of the sheath can be from about 10 nm to about 200 microns, or from about 50 nm to about 100 microns or from about 200 nm to about 50 microns.

In an embodiment core-sheath polymer fiber can be prepared by co-axial electrospinning of polymer core and the fluoropolymer (such as Viton) to form the non-woven core-sheath polymer fiber layer.

Examples of fluoropolymers useful as the sheath or coating of the polymer fiber include fluoroelastomers. Fluoroelastomers are from the class of 1) copolymers of two of vinylidenefluoride, hexafluoropropylene, and tetrafluoroethylene; 2) terpolymers of vinylidenefluoride, hexafluoropropylene, and tetrafluoroethylene; and 3) tetrapolymers of vinylidenefluoride, hexafluoropropylene, tetrafluoroethylene, and a cure site monomer. These fluoroelastomers are known commercially under various designations such as VITON A®, VITON B® VITON E® VITON E 60C®, VITON E430®, VITON 910®, VITON GH®; VITON GF®; and VITON ETP®. The VITON® designation is a trademark of E.I. DuPont de Nemours, Inc. The cure site monomer can be 4-bromoperfluorobutene-1,1,1-dihydro-4-bromoperfluorobutene-1,3-bromoperfluoropropene-1,1,1-dihydro-3-bromoperfluoropropene-1, or any other suitable, known cure site monomer, such as those commercially available from DuPont. Other commercially available fluoropolymers include FLUOREL 2170®, FLUOREL 2174®, FLUOREL 2176®, FLUOREL 2177® and FLUOREL LVS 76®, FLUOREL® being a registered trademark of 3M Company. Additional commercially available materials include AFLAS™ a poly(propylene-tetrafluoroethylene), and FLUOREL II® (LII900) a poly(propylene-tetrafluoroethylenevinylidenefluoride), both also available from 3M Company, as well as the Tecnoflons identified as FOR-60KIR, FOR-LHF®, NM® FOR-THF®, FOR-TFS®, TH®, NH®, P757®, TNS®, T439®, PL958®, BR9151® and TN505, available from Solvay Solexis.

Examples of three known fluoroelastomers are (1) a class of copolymers of two of vinylidenefluoride, hexafluoropropylene, and tetrafluoroethylene, such as those known commercially as VITON A®; (2) a class of terpolymers of vinylidenefluoride, hexafluoropropylene, and tetrafluoroethylene known commercially as VITON B®; and (3) a class of tetrapolymers of vinylidenefluoride, hexafluoropropylene, tetrafluoroethylene, and cure site monomer known commercially as VITON GH® or VITON GF®.

The fluoroelastomers VITON GH® and VITON GF® have relatively low amounts of vinylidenefluoride. The VITON GF® and VITON GH® have about 35 weight percent of vinylidenefluoride, about 34 weight percent of hexafluoropropylene, and about 29 weight percent of tetrafluoroethylene, with about 2 weight percent cure site monomer.

Examples of fluoropolymers useful as the sheath or coating on the polymer fiber core include fluoroplastics. Fluoroplastics suitable for use herein include fluoropolymers comprising a monomeric repeat unit that is selected from the group consisting of vinylidene fluoride, hexafluoropropylene, tetrafluoroethylene, perfluoroalkylvinylether, and mixtures thereof. Examples of fluoroplastics include polytetrafluoroethylene (PTFE); perfluoroalkoxy polymer resin (PFA); copolymer of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP), and mixtures thereof.

In embodiments, the electrospun fibers can have a diameter ranging from about 5 nm to about 50 μm, or ranging from about 50 nm to about 20 μm, or ranging from about 100 nm to about 1 μm. In embodiments, the electrospun fibers can have an aspect ratio about 100 or higher, e.g., ranging from about 100 to about 1,000, or ranging from about 100 to about 10,000, or ranging from about 100 to about 100,000. In embodiments, the non-woven fabrics can be non-woven nano-fabrics formed by electrospun nanofibers having at least one dimension, e.g., a width or diameter, of less than about 1000 nm, for example, ranging from about 5 nm to about 500 nm, or from 10 nm to about 100 nm.

After providing the non-woven fibers on the substrate, the graphene particles are deposited along the fibers in a uniform manner by coating a graphene particle dispersion and removing the solvent.

Any suitable type of graphene particles can be employed in the dispersion of the present disclosure. In an embodiment, the graphene particles can include graphene, graphene platelets and mixtures thereof. Graphene particles have a width of from about 0.5 microns to about 10 microns. In embodiments the width can be from about 1 micron to about 8 microns, or from about 2 microns to about 5 microns. Graphene particles have a thickness of from about 1 nanometer to about 50 nanometers. In embodiments the thickness can be from about 2 nanometers to about 8 nanometers, or from about 3 nanometers to about 6 nanometers. In an embodiment, graphene particles can have a relatively large per unit surface area, such as, for example, about 120 to 150 m²/g. Such graphene-comprising particles are well known in the art.

The graphene particles are dispersed in a solvent including water, and any organic solvents, toluene, hexane, cyclohexane, heptane, tetrahydrofuran, ketones, such as methyl ethyl ketone, methyl isobutyl ketone, cyclohexanone, N-Methylpyrrolidone (NMP); amides, such as dimethylformamide (DMF); N,N′-dimethylacetamide (DMAc), sulfoxides, such as dimethyl sulfoxide; alcohols, ethers, esters, hydrocarbons, chlorinated hydrocarbons, and mixtures of any of the above. The solid content of the dispersion of graphene particles is from about 0.1 weight percent to about 10 weight percent, or in embodiments from about 0.5 weight percent to about 5 weight percent of from about 1 weight percent to about 3 weight percent.

The graphene dispersion may further comprise a stabilizer selected from the group consisting of non-ionic surfactants, ionic surfactants, polyacids, polyamines, polyelectrolytes, and conductive polymers. More specifically the stabilizer includes polyacrylic acid, copolymer of polyacrylic acid, polyallylamine, polyethylenimine, polydiallyldimethylammonium chloride), poly(allylamine hydrochloride), poly(3,4-ehtylenedioxythiophene), poly(3,4-ethylenedioxythiophene) complexes with a polymer acid, Nafion (a sulfonated tetrafluoroethylene), gum arabic, and or chitosan. The amount of stabilizer in the graphene dispersion formulation ranges from about 0.1 percent to about 200 percent by weight of graphene particles, or from about 0.5 percent to about 100 percent by weight of graphene particles, or from about 1 percent to about 50 percent by weight of graphene particles.

A fluoropolymer coating is provided throughout the electrospun fibers having deposited graphene particles. The fluoropolymer coating composition can include, an effective solvent, in order to disperse the fluoropolymer that are known to one of ordinary skill in the art.

The fluoropolymer coating can include a fluoroelastomer which have been listed previously. Fluoroelastomers include copolymers of vinylidenefluoride, hexafluoropropylene and tetrafluoropropylene and tetrafluoroethylene, terpolymers of vinylidenefluoride, hexafluoropropylene and tetrafluoroethylene, tetrapolymers of vinylidenefluoride, hexafluoropropylene, tetrafluoroethylene, and a cure site monomer.

The fluoropolymer coating can include a fluoroplastic. Fluoroplastics includes polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP) and a cure site monomer; and mixtures thereof.

The fluoropolymer coating can include a cross-linked perfluoropolyether is available from Shin-Etsu (Tradename SIFEL®).

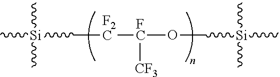

where n is a number of from about 0 to about 5000.

Therefore, the term “coating” or “coating technique” is not particularly limited in the present teachings, and dip coating, painting, brush coating, roller coating, pad application, spray coating, spin coating, casting, or flow coating can be employed.

The fluoropolymer coating is cured or melted at a temperature of from about 255° C. to about 360° C. or from about 280° C. to about 330° C.

Fluoropolymers suitable for use as in the release layer having the metal mesh include fluoropolymers listed previously. Fluoroplastics have a melting temperature of from about 280° C. to about 400° C. or from about 290° C. to about 390° C. or from about 300° C. to about 380° C. while fluoroelastomers are cured at a temperature of from about 80° C. to about 250° C.

The thermal resistivity the release layer of the electrospun fibers having graphene particles deposited thereon and a fluoropolymer dispersed throughout is from about 10² to about 10⁸ Ω/cm and the thermal conductivity is from about 0.25 W/mK to about 10 W/mK.

The release layer described herein has a thickness of from about 10 μm to about 400 μm, or from about 20 μm to about 300 μm, or from about 25 μm to about 200 μm.

Specific embodiments will now be described in detail. These examples are intended to be illustrative, and not limited to the materials, conditions, or process parameters set forth in these embodiments. All parts are percentages by solid weight unless otherwise indicated.

### EXAMPLES

### Electrospinning Process

A solution of about 8 weight percent fluorinated polyimide (FPI) in methyl ethyl ketone was loaded into a 10 mL syringe. A solution of 8 weight percent fluoroelastomer (Viton) in methyl ethyl ketone with 5 weight percent A0700 was loaded into a second 10 mL syringe. The two syringes were mounted into their respective syringe pumps, and the syringes were connected to the coaxial spinneret with the FPI on the core channel and the Viton on the shell channel. A roller substrate was wiped clean using isopropanol, and placed onto a fixture (with X-stage and rotation) approximately 15 cm away from the spinneret tip. About 20 kv was applied at the spinneret. Fibers with about 1 μm in diameter were generated and coated on the roll. The non-woven electorspun fibers were held at room temperature overnight and then heat-treated with to cure the fibers.

### Preparation of Graphene Dispersion

About 0.08 grams of graphene nanoplatelets (available from STREM, 06-0210) were dispersed in the 80 grams isopropanol and deionized water (1:1) containing 2.3 grams of poly(acrylic acid) water solution (35 weight percent). The dispersion was mixed by sonication for 150 minutes using a 60 percent setting for the power output.

### Flow-Coating Graphene Dispersion

The roller coated with electrospun fibers was mounted on a motorized rotation stage. The graphene dispersion was put in a syringe pump and the flow rate was set at 2 ml/min on the flow coating program. The rotational speed was 123 RPM and the coating speed was 2 mm/s. The coating was allowed to dry at room temperature overnight, followed by heating at 250° C. for 30 minutes to remove the solvents.

### Coating of Fluoropolymer

Crosslinkable perfluoropolyether was coated onto the graphene fabrics by flow-coating process. The coating was heated about 150° C. for 2 hours to result thermally conductive coatings.

The coating was uniform with a low surface energy.

It will be appreciated that variants of the above-disclosed and other features and functions or alternatives thereof may be combined into other different systems or applications. Various presently unforeseen or unanticipated alternatives, modifications, variations, or improvements therein may be subsequently made by those skilled in the art, which are also encompassed by the following claims.

What is claimed is:

1. A fuser member comprising:
a substrate; and
a release layer disposed on the substrate, the release layer having non-woven polymer fibers having graphene particles dispersed along the fibers and a fluoropolymer dispersed throughout the non-woven polymer fibers.

2. The fuser member of claim 1, wherein the graphene particle comprise from about 0.1 weight percent to about 20 weight percent of the release layer.

3. The fuser member of claim 1, wherein the graphene particles have a width of from about 0.5 microns to about 10 microns.

4. The fuser member of claim 1, wherein the graphene particles have a thickness of from about 1 nanometer to about 50 nanometers.

5. The fuser member of claim 1, wherein polymer fibers comprise a material selected from the group consisting of: a polyamide, a polyester, a polyimide, a polycarbonate, a polyurethane, a polyether, a polyoxadazole, a polybenzimidazole, a polyacrylonitrile, a polycaprolactone, a polyethylene, a polypropylene, a acrylonitrile butadiene styrene (ABS), a polybutadiene, a polystyrene, a polymethyl-methacrylate (PMMA), a polyhedral oligomeric silsesquioxane (POSS), a poly(vinyl alcohol), a poly(ethylene oxide), a polylactide, a poly(caprolactone), a poly(ether imide), a poly(ether urethane), a poly(arylene ether), a poly(arylene ether ketone), a poly(ester urethane), a poly(p-phenylene terephthalate), a cellulose acetate, a poly(vinyl acetate), a poly(acrylic acid), a polyacrylamide, a polyvinylpyrrolidone, hydroxypropylcellulose, a poly(vinyl butyral), a poly(alkly acrylate), a poly(alkyl methacrylate), polyhydroxybutyrate, fluoropolymer, a poly(vinylidene fluoride), a poly(vinylidene fluoride-co-hexafluoropropylene), a fluorinated ethylene-propylene copolymer, a poly(tetrafluoroethylene-co-perfluoropropyl vinyl ether), a poly((perfluoroalkyl)ethyl methacrylate), a cellulose, a chitosan, a gelatin, a protein, and mixtures thereof.

6. The fuser member of claim 1, wherein non-woven polymer fibers comprise a fluorinated polyimide having a chemical structure as follows: 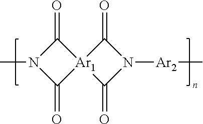
wherein Ar₁ and Ar₂ independently represent an aromatic group of from about 4 carbon atoms to about 100 carbon atoms, and wherein at least one of Ar₁ or Ar₂ further contains a fluoro-pendant group, and wherein n is from about 30 to about 500.

7. The fuser member of claim 1, wherein the non-woven polymer fibers have a fluoropolymer sheath.

8. The fuser member of claim 1, wherein the fluoropolymer comprises a fluoroelastomer selected from the group consisting of copolymers of: vinylidenefluoride, hexafluoropropylene and tetrafluoropropylene and tetrafluoroethylene, terpolymers of vinylidenefluoride, hexafluoropropylene and tetrafluoroethylene, tetrapolymers of vinylidenefluoride, hexafluoropropylene, tetrafluoroethylene, and a cure site monomer.

9. The fuser member of claim 1, wherein the fluoropolymer comprises a fluoroplastic selected from the group consisting of: polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP) and a cure site monomer; and mixtures thereof.

10. The fuser member of claim 1, wherein the fluoropolymer comprises a perfluoropolyether.

11. A method of manufacturing a fuser member, the method comprising:
providing a conductive surface;
electrospinning polymeric fibers on the conductive surface to form a non-woven polymer fiber layer;
flow coating a dispersion comprising graphene particles and a first solvent on the non-woven polymer fiber layer;
removing the first solvent to form a non-woven polymer fiber layer having graphene particles deposited along the polymeric fibers;
coating a mixture of a fluoropolymer and a second solvent on the non-woven polymer fiber layer having graphene particles deposited along the polymeric fibers;
heating the mixture to remove the second solvent and melt or cure the fluoropolymer to form a release layer.

12. The method of claim 11, wherein the dispersion comprises, graphene particles having a width of from about 0.5 microns to about 10 microns.

13. The method of claim 11, wherein the graphene particles have a thickness of from about 1 nanometer to about 50 nanometers

14. The method of claim 11, wherein the dispersion further includes a stabilizer.

15. The method of claim 14, wherein the stabilizer is selected from the group consisting of: non-ionic surfactants, ionic surfactants, polyacids, polyamines, polyelectrolytes, and conductive polymers.

16. The method of claim 14, wherein the stabilizer is selected from the group consisting of: polyacrylic acid, copolymer of polyacrylic acid, polyallylamine, polyethylenimine, poly(diallyldimethylammonium chloride), poly(allylamine hydrochloride), poly(3,4-ehtylenedioxythiophene), poly(3,4-ethylenedioxythiophene) complexes with a polymer acid, sulfonated tetrafluoroethylene, gum arabic and chitosan.

17. The method of claim 14, wherein the stabilizer in the dispersion formulation is present in amount of from about 0.1 percent to about 200 percent by weight of graphene particles.

18. The method of claim 11, wherein the graphene particles comprise from about 0.1 weight percent to about 20 weight percent of the release layer.

19. A fuser member comprising:
a substrate;
an intermediate layer disposed on the substrate; and
a release layer disposed on the intermediate layer, the release layer having non-woven polymer fibers having graphene particles dispersed along the fibers and a fluoropolymer dispersed throughout the non-woven polymer fibers.

20. The fuser member of claim 1, wherein the graphene particles have a width of from about 0.5 microns to about 10 microns and a thickness of from about 1 nanometer to about 50 nanometers.
